(19) United States
(12) Patent Application Publication
(10) Pub. No.: US 2019/0204417 A1
(43) Pub. Date: Jul. 4, 2019

(54) GROUND CONTROL TARGET

(71) Applicant: Brendan Thompson, Broomfield, CO (US)

(72) Inventor: Brendan Thompson, Broomfield, CO (US)

(21) Appl. No.: 15/862,108

(22) Filed: Jan. 4, 2018

(51) Int. Cl. G01S 7/48; G01C 11/00; G01S 17/89

(52) U.S. Cl. CPC G01S 7/4802; G01S 17/89; G01C 11/00

(57) ABSTRACT

A ground control target includes a solid piece of plastic that is disk-shaped and convex at a top and a center of the solid piece of plastic, to shed water off edges thereof and to diffuse direct sunlight and minimize glare. The ground control target further defines an aperture through the center of the solid piece of plastic through which to fasten the solid piece of plastic to the ground.

### BACKGROUND

Ground control points or targets or markers are employed in aerial surveying to produce highly accurate and reliable georeferenced mapping products for both photogrammetric and LiDAR data collection methods. Selection and design of the ground control targets can make a significant impact on accuracy and precision of location detection. Surveyors have improvised the use of ground control targets over the years, to include homemade targets or spray painting crosses on the ground. These methods generally result in inaccuracies in field global positioning system (GPS) data collection and in photogrammetric data processing based on this data collection due to the difficulty in pinpointing the absolute center of these targets. Redundant imprecision in the x-y-z coordinates from both the field survey and during image processing may have significant impacts on the resulting accuracy of final map products.

In regards to spray-painted targets, the possibility for x-coordinate and y-coordinate errors is common due to the typical patterns presenting centering challenges for both surveyor and processor. Also, the use of paint is expensive due to the high number of targets required for homogeneous site coverage as well as high volumes required to create targets large and contrasting enough to be visible from the air. This inexact, messy, and time-consuming method contributes to inefficiencies in the field and results in added costs as well as decreased mapping precision. Furthermore, during pixel selection, a processor is to select the pixel that is closest to the actual surveyed x-y-z coordinate. Being off by a single pixel, which is common with painted targets, means processing with measurements that are off by several inches, depending on the native ground sample distance. The result is a processed dataset with low quality geospatial mapping products that fail to meet the accuracy requirements of the project.

Other ground control targets have recently become available to consumers, but are generally either too expensive, cumbersome when transported on foot, and/or made of light and delicate materials that do not hold up the rigors of an outdoor environment. Some of these ground control targets include large polymerizing vinyl chloride (PVC) sheets that require multiple attachment locations to the ground (and thus many heavy nails to pin them down), easily rip and blow away, and impact the z-direction accuracy. As illustrated in FIG. 3A, an unmanned aerial system (UAS), or drone, GPS z-coordinate may be determined at a point based on positioning of a PVC-based ground control target. For example, the z-coordinate point may be determined from processing the data collected by the UAS during overflight. At a different time, FIG. 3B illustrates the determination of an x-y-z coordinate taken with a surveying pole. Note that the PVC sheeting easily gives way and is pushed a distance of Δz through grass or other ground cover to the soil. This Δz, ranging up to 4 cm or more, creates inaccurate positioning data in at least the z-direction.

### BRIEF DESCRIPTION OF THE DRAWINGS

Various exemplary implementations of the present disclosure will be understood more fully from the detailed description given below and from the accompanying drawings of various exemplary implementations of the disclosure.

FIG. 1A is a top plane view of a ground control target according to an embodiment.

FIG. 1B is a side view of the ground control target of FIG. 1A, according to one embodiment.

FIG. 1C is a side view of the ground control target of FIG. 1A, illustrating an aperture reinforcement cylinder, according to another embodiment.

FIG. 1D is an enlarged view of the aperture reinforcement cylinder of FIG. 1C, according to one embodiment.

FIG. 1E is a top plane view of the aperture reinforcement cylinder of FIG. 1C according to an embodiment.

FIG. 2A is a series of images captured of the disclosed ground control target by a DJI Zenmuse X3 unmanned aerial system (UAS) camera from three different heights, according to an embodiment.

FIG. 2B is a series of images captured of the disclosed ground control target by a Sony a5100, 16 mm camera from three different heights, according to an embodiment.

FIG. 2C is a series of images captured of the disclosed ground control target by a Sony a5100, 20 mm camera from three different heights, according to an embodiment.

FIG. 2D is a series of images captured of the disclosed ground control target by a Sony a7R II, 35 mm camera from three different heights, according to an embodiment.

FIG. 3A is a side view illustration of obtaining a UAS GPS z-coordinate from a polymerizing vinyl chloride (PVC) sheet ground control target, according to an embodiment.

FIG. 3B is a side view illustration of obtaining a surveyed GPS z-coordinate from the PVC sheet ground control target illustrated in FIG. 3A, according to an embodiment.

### DETAILED DESCRIPTION

The disclosed ground control target overcomes the above-discussed deficiencies in current ground control point generation and deployment. The disclosed ground control target may be disk-shaped and pancake-shaped in having a convex top surface (e.g., upward face), leading a thicker middle portion and to thinner edges so that water is shed off of the top of the ground control target. The convex shape may also decrease direct reflection of sunlight back into a unmanned aerial system (UAS), or drone's, camera sensors, thereby avoiding overexposure of the sensors that may cause reduction in pixel data of the ground control target due to sunlight glare.

In various embodiments, in being disk-shaped, the ground control target may define (e.g., include) an aperture in a center of the ground control target. The aperture may receive a nail that may be driven into the ground (or earth) to fasten the ground control target in place. A survey rod may then be placed on top of the fastening nail. The survey rod is used to collect position data, e.g., highly accurate ground surface GPS coordinates for topographic survey and accurate geo-referencing of remote sensing mapping products.

Furthermore, a distinctive colored pattern may be painted, printed, dyed, stamped or otherwise covered on the top surface of the ground control target using a matte paint, ink, dye, or decal that reduces light reflection from the sun. The colored patterns may increase the contrast with uncolored portions of the top surface. The reduction in reflection may help reduce glare within the images taken from UAS cameras during overflight data acquisition of the ground control target and surrounding area.

In various embodiments, the ground control target may be a single piece of plastic made of a thermoplastic elastomer that includes polypropylene, e.g., a thermoplastic elastomer and polypropylene blend. This plastic blend may cause the ground control target to be rubber-like, and therefore heavy enough to not be carried away by the wind, and resilient enough to not be easily damaged through repeated deployments to different surveying sites.

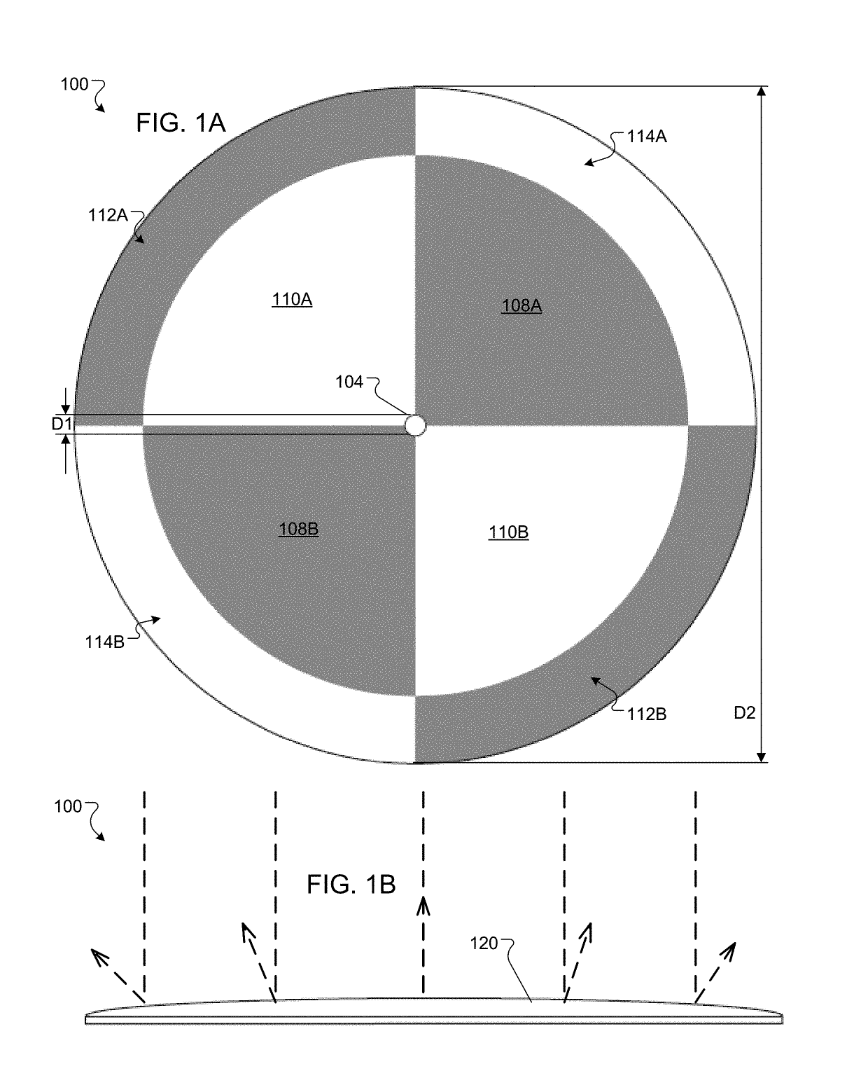

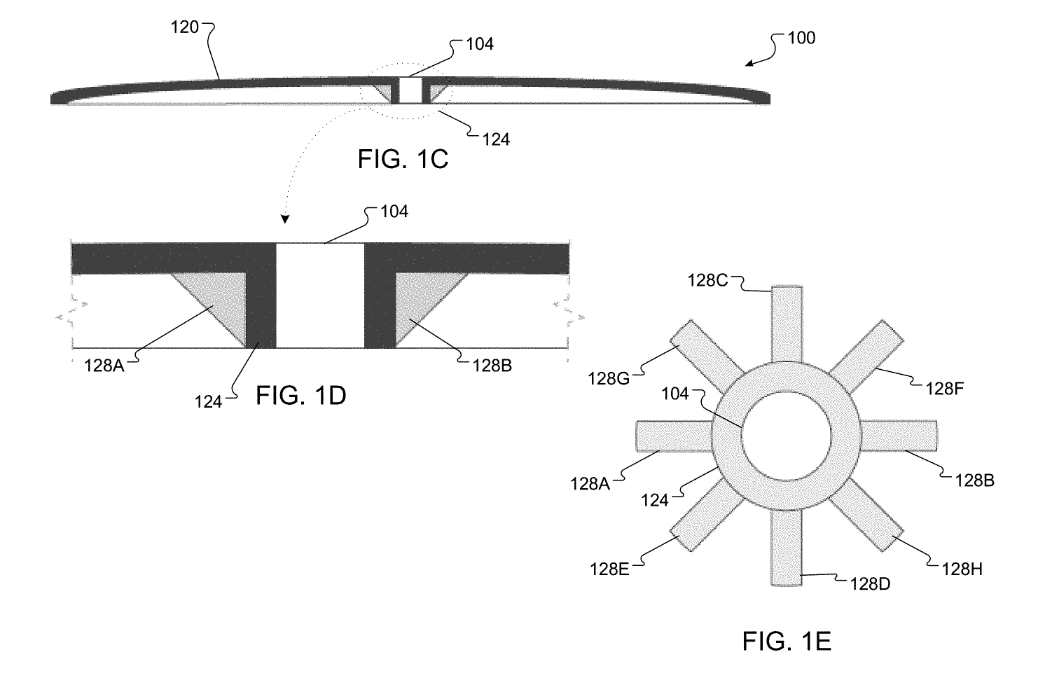

FIG. 1A is a top plane view and FIG. 1B is a side view of a ground control target 100 according to an embodiment. The ground control target 100 may include an aperture of at least ⅜″ diameter (D1) that is defined through a center of the ground control target 100. The ground control target 100 may itself have a diameter (D2) between about 12″ and 24″, which is generally large enough to be seen 100 feet to 400 feet in the air where drones typically fly. The ground control target 100 may be disk-shaped and may be convex on a top surface 120 such that edges of the ground control target 100 are thinner, to shed water off, thus avoiding damage from standing water. With continued reference to FIG. 1B, the convex shape may also decrease direct reflection of sunlight back into a drone's camera sensors, e.g., cause light diffusion, which may otherwise occur with a flatter surface, thereby avoiding overexposure of the sensors that may cause reduction in pixel data of the ground control target due to sunlight glare. In other words, the convex surface may better diffuse the light into multiple directions with fewer if any reflections being focused directly back into a drone's camera sensors.

In some embodiments, the top surface 120 of the ground control target 100 is covered with a distinctive colored pattern to provide a contrast that helps with detection of the center of the ground control target 100. For example, the top surface of the ground control target 100 may include color applied to form a set of triangular shapes 108A and 108B on opposing sides of the aperture, leaving a second set of triangular shapes 110A and 110B where color is absent or missing. Where color is absent, the top surface of the ground control target 100 may be colored with a set of partial ring patterns 112A and 112B along an outer edge of the top surface of the ground control target 100. This pattern may leave a second set of partial ring patterns 114A and 114B along an outside of the colored set of triangular shapes 108A and 108B, respectively.

In various embodiments, the colored regions and the regions absence of color (e.g., white or substantially white in color) may be applied with paint, ink, dye, a decal, or other covering. Any of these coverings or layers may employ a matte finish that reduces reflection from the sun, and thus also increases the contrast of the contrast of the colored portions with respect to the uncolored portions of the top surface. The reduction in reflection may help reduce glare within the images taken from UAS cameras during over flight data acquisition over GPS targets, and thus aid in accurate detection of the center of the ground control target 100.

Furthermore, the ground control target 100 may be a solid piece of plastic or plastic composite (e.g., a solid piece of rubberized plastic) for maximum strength, although different pieces of plastic may be melded together or joined to create a single disk-shaped ground control target 100. The plastic may be a thermoplastic elastomer that includes some polypropylene blended in, to make the plastic rubber-like and therefore more resilient to bending and to high force of impact without breaking. In one embodiment, the ground control target 100 is a rigid molded rubberized plastic such as a Hytrel® and polypropylene blend. Such a plastic, or other similar blend, may be impact resistant, resistant to abrasion, and water resistant, which makes the ground control target 100 resistant to wear and tear of rigorous survey work. An elastomeric polymer and polypropylene blend may also be more impact resistant in a larger range of temperatures when compared with high density polyethylene (HDPE) or other such materials.

FIG. 1C is a side view of the ground control target 100 of FIG. 1A, illustrating an aperture reinforcement cylinder 124 (or just “cylinder”), according to another embodiment. FIG. 1D is an enlarged view of the aperture reinforcement cylinder of FIG. 1C, according to one embodiment. FIG. 1E is a top plane view of the aperture reinforcement cylinder 124 of FIG. 1C according to an embodiment. The aperture reinforcement cylinder 124 may extend at least through a portion of the aperture 104 and may have at least one extended piece that, in one embodiment, extends the entirety of the aperture 104. The aperture reinforcement cylinder 124 may be made of a material that is harder than the plastic of the ground control target 100. For example, the aperture reinforcement cylinder 124 may be made of metal or a harder plastic and/or rubber.

The aperture reinforcement cylinder 124 may be at least 4 mm thick, although the thickness may vary and still provide the desired reinforcement, to prevent premature damage to the aperture 104. The aperture reinforcement cylinder 124 may further include at least a pair of opposing fins 128A and 128B (or flanges), which may be slanted in on embodiment. In a further embodiment (FIG. 1E), the aperture reinforcement cylinder 124 includes at least a second pair of opposing fins 128C and 128D. In still further embodiments, the aperture reinforcement cylinder 124 includes a third pair of opposing fins 128E and 128F and optionally a fourth pair of opposing finds 128G and 128H.

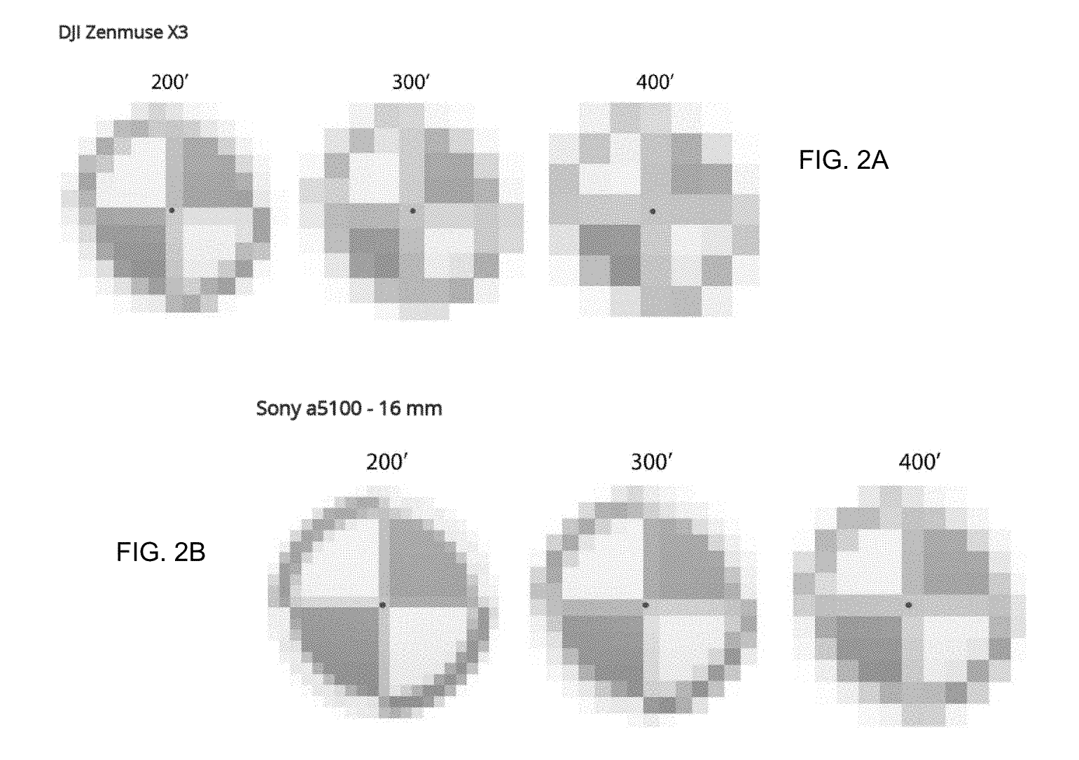

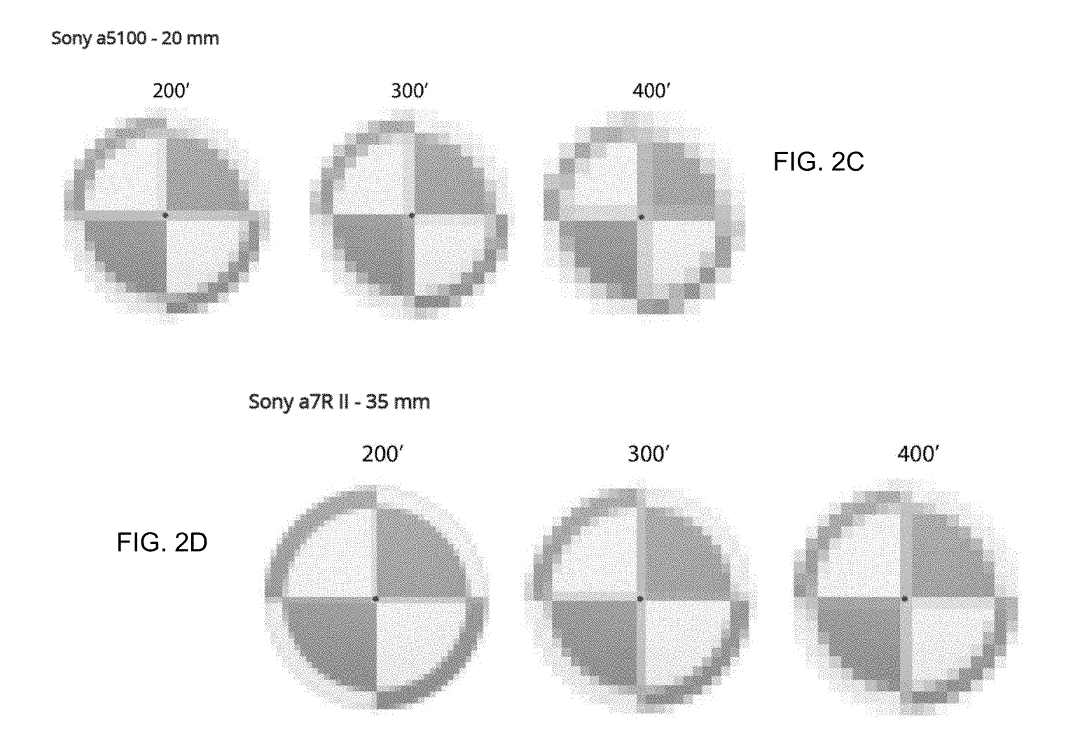

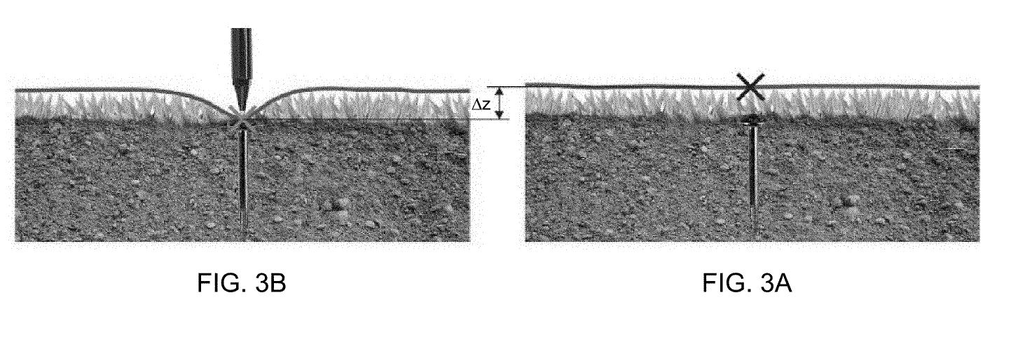

Ground sample distance (GSD) may vary depending on type of sensor, lense focal length, and flight altitude above the ground of a drone during data collection processes. Estimated GSD values are calculated and displayed in Table 1. FIGS. 2A, 2B, 2C, and 2D illustrate a depiction of the image captured for each of the four different drone cameras of Table 1 at 200 feet, 300 feet, and 400 feet. Note that the camera detection of the center of the target becomes slightly less accurate at higher altitude and when using a sensor with lower pixel density.

TABLE 1

| Flight | DJI | BST a5100 | BST a5100 | BST a7RII |
|---|---|---|---|---|
| Height | Zenmuse X3 | 16 mm | 20 mm | 35 mm |
| 200′ | 2.5 cm | 1.5 cm | 1.6 cm | 0.8 cm |
| | (1.0 in) | (0.6 in) | (0.63 in) | (0.31 in) |
| 300′ | 3.8 cm | 2.2 cm | 1.8 cm | 1.2 cm |
| | (1.5 in) | (0.87 in) | (0.71 in) | (0.47 in) |
| 400′ | 5.0 cm | 3.0 cm | 2.4 cm | 1.6 cm |
| | (2.0 in) | (1.18 in) | (0.94 in) | (0.63 in) |

FIG. 2A is a series of images captured of the disclosed ground control target by a DJI Zenmuse X3 (12 megapixels) unmanned aerial system (UAS) camera from three different heights, according to an embodiment. FIG. 2B is a series of images captured of the disclosed ground control target by a Sony a5100 (24 megapixels), 16 mm camera from three different heights, according to an embodiment. FIG. 2C is a series of images captured of the disclosed ground control target by a Sony a5100, 20 mm camera from three different heights, according to an embodiment. FIG. 2D is a series of images captured of the disclosed ground control target by a Sony a7R II (42 megapixels), 35 mm camera from three different heights, according to an embodiment.

As shown in the above examples, cross markings effectively and accurately denote center points on top surfaces 120 (e.g., upward facing surfaces) of ground control targets while monochromatic targets make it very difficult to conduct efficient photogrammetric processes that detect the center. Increases in efficiency will be seen for field surveyors because of the reduction in number of nails/pins/stakes required to secure the target to the ground, where one fastener per target is used as opposed to the four required for other products. Surveyors will also avoid the time-consuming and costly practices of painting ground targets, whether the painting is performed by template or freehand.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and may not necessarily have an ordinal meaning according to their numerical designation.

The above description sets forth numerous specific details such as examples of specific systems, components, methods, and so forth, in order to provide a good understanding of several embodiments. It will be apparent to one skilled in the art, however, that at least some embodiments may be practiced without these specific details. In other instances, well-known components or methods are not described in detail or are presented in simple block diagram format in order to avoid unnecessarily obscuring the present embodiments. Thus, the specific details set forth above are merely exemplary. Particular implementations may vary from these exemplary details and still be contemplated to be within the scope of the present embodiments.

It is to be understood that the above description is intended to be illustrative and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A ground control target comprising:
a solid piece of plastic that:
is disk-shaped;
has a top surface that is convex, to shed water off edges thereof; and
defines an aperture through a center of the top surface through which to fasten the solid piece of plastic to the ground.

2. The ground control target of claim 1, wherein a diameter of the solid piece of plastic is between approximately 12″ and approximately 24″.

3. The ground control target of claim 1, wherein the plastic is a thermoplastic elastomer that includes polypropylene.

4. The ground control target of claim 1, wherein the solid piece of plastic includes a cylinder to reinforce the aperture, the cylinder being of a harder material than the plastic and extending through at least a portion of the aperture.

5. The ground control target of claim 4, wherein the cylinder further comprises a pair of opposing fins extending perpendicularly within the plastic of the solid piece of plastic.

6. The ground control target of claim 1, wherein the aperture is at least ⅜″ in diameter.

7. The ground control target of claim 1, wherein the top surface of the solid piece of plastic comprises color applied to form a set of triangular shapes on opposing sides of the aperture, and where color is absent between the set of triangular shapes, the top surface of the solid piece of plastic is colored with a partial ring pattern along an outer edge of the top surface of the solid piece of plastic.

8. The ground control target of claim 7, wherein the color and the absence of color applied on the top surface comprises a matte paint to reduce light reflection.

9. A apparatus comprising a ground control target that:
is circular;
is pancake-shaped in being thicker in a middle thereof compared to edges thereof, to reduce glare from sunlight reflecting off a top surface of the ground control target;
defines an aperture through a center of the ground control target at which to place a survey rod to obtain position data of the ground control target; and
is made of a blend of a thermoplastic elastomer and polypropylene.

10. The apparatus of claim 9, wherein a diameter of the ground control target is between approximately 12″ and approximately 24″.

11. The apparatus of claim 9, further comprising a cylinder to reinforce the aperture, the cylinder being of a harder material than the ground control target and extending through at least a portion of the aperture, and wherein the cylinder further comprises a pair of opposing fins extending perpendicularly within the ground control target.

12. The apparatus of claim 9, wherein the aperture is at least ⅜″ in diameter.

13. The apparatus of claim 9, wherein the top surface of the ground control target comprises color applied to form a set of triangular shapes on opposing sides of the aperture, and where color is absent between the set of triangular shapes, the top surface of the ground control target is colored with a partial ring pattern along an outer edge of the top surface of the ground control target.

14. The apparatus of claim 13, wherein the color and the absence of color applied to the top surface comprises one of a matte ink or a matte decal, to reduce light reflection.

15. An apparatus comprising:
a solid piece of rubberized plastic that is pancake-shaped and defines an aperture through a center of the solid piece of rubberized plastic through which to fasten the solid piece of plastic to the ground for use as a ground control target, wherein the solid piece of rubberized plastic is between approximately 12″ and 24″ in diameter; and
a cylinder to reinforce the aperture, the cylinder being of a harder material than the rubberized plastic and extending through at least a portion of the aperture.

16. The apparatus of claim 15, wherein the rubberized plastic is a thermoplastic elastomer that includes polypropylene.

17. The apparatus of claim 15, wherein the cylinder further comprises a pair of opposing fins extending perpendicularly within the rubberized plastic of the solid piece of plastic.

18. The apparatus of claim 15, wherein the aperture is at least ⅜″ in diameter.

19. The apparatus of claim 15, wherein a top surface of the solid piece of rubberized plastic comprises color applied to form a set of triangular shapes on opposing sides of the aperture, and where color is absent between the set of triangular shapes, the top surface of the solid piece of rubberized plastic is colored with a partial ring pattern along an outer edge of the top surface of the solid piece of rubberized plastic.

20. The apparatus of claim 19, wherein the color and the absence of color applied to the top surface comprises one of a matte dye or a matte paint to substantially eliminate light reflection.
